(19) United States
(12) Patent Application Publication
(10) Pub. No.: US 2008/0064802 A1
(43) Pub. Date: Mar. 13, 2008

(54) Method for polymer-polymer compatiblization and non polymer filler dispersion and compositions made therefrom

(76) Inventors: David Abecassis, Huntington, NY (US); Ed Wiegel, Baltimore, MD (US)

Correspondence Address: Attention: Thomas A. O'Rourke;Bodner & O'Rourke, 425 Broadhollow Road, Melville, NY, 11747, US

(21) Appl. No.: 11/881,407

(22) Filed: Jul. 26, 2007

Related U.S. Application Data
(63) Continuation-in-part of application No. 11/645,093, filed on Dec. 22, 2006.
(60) Provisional application No. 60/833,448, filed on Jul. 26, 2006.

(51) Int. Cl. C08K 3/32; C08K 3/22; C08K 3/26

(52) U.S. Cl. 524/414; 524/425; 524/430

(57) ABSTRACT

Thermoplastic homogeneous blends are disclosed. The blends are made up of one or more thermoplastic polymers, one or more clays, one or more diphosphates and a filler and wherein the diphosphate and the clay become intercalated and exfoliated with said thermoplastic and filler to form a nanocomposite.

This application claims priority on U.S. Application Ser. No. 60/833,448 filed Jul. 26, 2006, the disclosures of which are incorporated herein by reference. 006. This application is a continuation in part of U.S. application Ser. No. 11/645,093 filed Dec. 22, 2006, the disclosures of which are incorporated herein by reference.

### FIELD OF THE INVENTION

The present invention is directed towards the field of thermoplastic nanocomposite blends of one or more polymers and one or more fillers or other additives. The polymers are preferably thermoplastic polymers and the fillers are preferably solid fillers.

### BACKGROUND OF THE INVENTION

Thermoplastic polymers are often blended with fillers or other additives to alter the properties of the thermoplastic material. These fillers typically are solid fillers which range from cost reducing minerals, i.e. materials which are cheaper to use than the thermoplastic resin used in the blend, to high value added fillers such as flame retardants. There are also electrically or thermally conductive filler materials that also are added to thermoplastic polymers to provide specific properties to the thermoplastic material. The uniformity of distribution of these fillers in the plastic matrix of the thermoplastic resin are critical to achieving uniformity of mechanical as well as other properties in the thermoplastic/filler blend. It appears that the more costly the filler, and the more important the mechanical performance of the thermoplastic polymer based plastic/nanocomposite, the more important this uniformity of dispersion of the filler becomes to the overall value and performance of the thermoplastic/filler blend. In addition, recent work in the area of immiscible polymer compatiblization has shown that in addition to the traditional block-copolymers which have been used to compatiblize different polymer; molecules such as maleic anhydride grafted polymers and quaternary amine treated clays can also be used to compatiblize polymers with other polymers.

The value of being able to blend polymers is multi-fold. First it allows materials researchers to develop blends which allow the superimposing of the desirable properties of two or more polymers. A good example would be combining the chemical resistance of polypropylene with the impact and stiffness properties of HIPS (High Impact Polystyrene). Both materials have complementary properties which are mutually beneficial when combined. There are many different possible combinations, but under normal circumstances the blended materials are often incompatible, and blend poorly resulting in a low quality extruded products.

These immiscible polymers, when melted together, form small bubbles or inclusions of pure polymer in the blends. These inclusions are called domains. The larger the size of these domains generally the poorer the properties of the blend. These domains are often only visible under microscope. If the material is compatibilized, then the individual domains shrink considerably to a fraction of their original size. This is due to a reduction of the interstitial energy (i.e. “surface tension” at the interface) between the domains. This energy is at the interface of the different domains, and the higher it's value, the larger the domain. Compatiblization reduces this energy by mechanical, physical or chemical means.

A second reason to be able to blend immiscible polymers is that it allows for the wider use of scrap thermoplastic in recycled products. In many processes using thermoplastics such as parison blow molding, injection blow molding etc. a significant quantity of scrap can be generated. Particularly in the manufacture of multi layered products, incompatible polymer scrap generation can be a major problem. Applications which can put scrap to use are highly advantageous. Scrap use means that plastics manufacturing can shift from using petroleum raw-material virgin plastic, to more recycled waste instead thereby reducing costs and environmental impact. For many plastics manufactures, this difference can be the difference between paying for raw material, and being paid to accept raw materials. Many scrap generation sources will pay to have the scrap removed. For example, small mountains of PVC and PP/PE waste contaminated with Teflon can be found in municipalities where copper recycling took place on an industrial scale. Carpet scrap is an example of a contaminated source of nylon which can generate revenue when it is removed from the originator. So in essence compatiblization enables a different, more profitable economic model for many plastics manufacturers; while decreasing the generation of unused plastic waste.

### OBJECTS OF THE INVENTION

It is an object of the invention provide a means for forming processable polymer blends from immiscible polymers.

It is another object of the invention is to provide uniform plastic alloys from nearly immiscible blends

Another object of the invention is, through the use of an inexpensive compatibilizer, enable industrial scale polymer blending without raw material limitations on the compatibilizer.

Still further object of this invention is to provide better dispersion of one or more solid fillers in one or more thermoplastic polymers for better filler performance in the thermoplastic polymer.

Yet another object of this invention is to provide for better acceptance of solid particle fillers in polymer-polymer blends.

Still another object of this invention is to develop a compatibilizer for enhanced recycling properties in thermoplastic polymers and nanocomposites.

### SUMMARY OF THE INVENTION

The present invention is directed to the use of diphosphates including but not limited to resorcinol diphosphate (RDP) and bis-phenol diphosphate (BDP) treated clays as polymer-polymer blending compatibilizers and/or filler-polymer dispersing agents. The invention is directed towards thermoplastics and thermoplastic nanocomposites made therefrom. The organoclays formed from the clay diphosphate blends are preferably added to the melt polymer after the diphosphate has been mechanically blended with the clay. In a preferred embodiment the melt blend polymer with the organoclay and the filler or other polymer being added to the blend are subjected to high shear during thermoplastic processing. A twin screw extrusion or the use of methods which achieve equal or greater shear are preferred embodiments.

### DETAILED DESCRIPTION OF THE INVENTION

The thermoplastic plastic polymeric materials particularly suitable in the present invention include but are not limited to such polymers as high impact polystyrene (HIPS), polypropylene (PP), polymethylmethacrylate (PMMA), Acrylonitrile Butadiene Styrene (ABS), Polycarbonate and Nylon. The fillers that can be used with the thermoplastic polymers can include but are not limited to:

glass beads

glass fiber

metal oxides

halogenated organic solids

phosphate based solids

mineral salts

extenders (such as sawdust, calcium carbonate, etc.)

carbon black

sand/silica

natural fibers

diatomaceous earth

metal fibers

metal particles.

The preferred fillers are typically solid fillers.

The compatibilizer for blending one or more thermoplastic polymers either alone or with one or more fillers is preferably a blend of a clay and a diphosphate. The preferred clays used in the invention as organo-functionalized compatibilizers are typically smectite clays. A smectite is a naturally occurring clay mineral selected from a group consisting of hectorite, montmorillonite, bentonite, beidelite, saponite, stevensite and mixtures thereof. A particularly preferred choice for the smectite is montmorillonite. The preferred choice of organic treatment for the organoclay compatibilizer is a diphosphate such as a resorcinol diphosphate (RDP) or a bisphenol diphosphate (BDP) or blends thereof. The clay may be initially blended with the diphosphate. The clay/diphosphate blend can then be blended with two or more thermoplastic materials. Alternatively, a thermoplastic polymer can be blended with the clay-diphosphate blend and a filler can be added thereto. In this example, the clay-diphosphate blend acts as a dispersing agent for the filler.

It will be appreciated that the composition of the present invention can be formed in different by altering the order of the addition of the blend materials as desired. For example thermoplastic polymer and diphosphate can be blended and then clay can be added to the blend etc.

The RDP and/or BDP organo-functionalized clay reduces the interstitial energy in a polymer. The diphosphate/clay blend forms an intercalated and exfoliated structure, and allows for the blending of the polymer with other polymers or fillers. RDP/BDP organoclays use surface energy, tackiness, and chemical affinity with a given polymer to compatiblize it's blending with another polymer or filler at the interface with the polymer. This differs in the compatiblization mechanism obtained with quaternary amine treated organoclays; where actual physical bending of individual clay platelets absorbs the energy at the polymer-polymer and polymer-solid interfaces.

In addition, RDP has been shown to physically attract and bind solid particles to it's surface with either physical adsorption or affinity wetting. This means that as the clay uniformly disperses in the melt blend, it draws particles into a well dispersed state by a combination of entrainment and surface interaction. The resulting thermoplastic/and or nanocomposite has thus much greater filler uniformity due to better wetting of the melt phase polymer and better spatial distribution. The degrees to which these mechanisms are active in a given thermoplastic polymer gives the corresponding enhanced properties from the enhanced dispersion/and or compatiblization.

A TEM (transmission electron microscopy) taken of a blend of the present invention that has a thermoplastic and a filler blended with a diphosphate clay shows visibly smaller polymer domains when compared to a non compatibilized blend control of the composition without the diphosphate. The compatibilized blend of the present invention also has at least 10% greater flexural modulus when using ASTM D-790-00, compared to a non diphosphate treated control. The compatibilized blend of the present invention also has at least 10% greater flexural modulus when using a dynamic mechanical analyzer compared to a non diphosphate treated control. When an SEM-EDX (scanning electron microscopy with X-ray element identification) is taken of the composition of the present invention the SEM shows a greater particle dispersion than a non diphosphate treated control. Similar results are obtained when an X-ray diffraction pattern with the diphosphate treated clay composition is taken. The diffraction pattern shows greater uniform filler distribution throughout the thermoplastic polymer blend of the present invention than does a non diphosphate treated control.

In a preferred embodiment of the present invention the diphosphate treated clay comprises 0.1%-50% by weight of the blend. Preferably, the diphosphate treated clay is added into a melt phase of the thermoplastic polymer during processing.

I claim:

1) A thermoplastic nanocomposite composition comprising one or more thermoplastic polymers blended with one or more clays and one or more diphosphates and one or more non thermoplastic fillers.

2) The composition according to claim 1 wherein said diphosphate is a resorcinol diphosphate.

3) The composition according to claim 1 wherein said diphosphate is a bisphenol diphosphate.

4) The composition according to claim 1 wherein said filler is a solid filler.

5) The composition of claim 4 wherein said clay is a smectite clay selected from the group consisting of hectorite, montmorillonite, bentonite, beidelite, saponite, stevensite and mixtures thereof.

6) A thermoplastic homogeneous blend comprising one or more thermoplastic polymers, one or more clays, one or more diphosphates and one or more fillers and wherein the diphosphate and the clay become intercalated and exfoliated with said thermoplastic and filler.

7) The composition of claim 6 wherein said diphosphate is resocinal diphosphate.

8) The composition according to claim 6 wherein said diphosphate is bisphenol diphosphate.

9) The composition according to claim 6 wherein the diphosphate binds solid particles of clay to its surface thereby uniformly dispersing the clay in the melt blend with the thermoplastic.

10) The composition according to claim 9 wherein said filler is glass beads.

11) The composition according to claim 9 wherein said filler is glass fiber.

12) The composition according to claim 9 wherein said filler is a metal oxide.

13) The composition according to claim 9 wherein said filler is a halogenated organic solid.

14) The composition according to claim 9 wherein said filler is a phosphate based solid.

15) The composition according to claim 9 wherein said filler is a mineral salt.

16) The composition according to claim 9 wherein said filler is an extender.

17) The composition according to claim 16 wherein said extender is sawdust.

18) The composition according to claim 16 wherein said extender is calcium carbonate.

19) The composition according to claim 9 wherein said filler is carbon black.

20) The composition according to claim 9 wherein said filler is sand/silica.

21) The composition according to claim 9 wherein said filler is natural fibers.

22) The composition according to claim 9 wherein said filler is diatomaceous earth.

23) The composition according to claim 9 wherein said filler is metal fibers.

24) The composition according to claim 9 wherein said filler is metal particles.

25) The composition according to claim 6 wherein said diphosphate treated organoclay is a dispersing agent for said filler/polymer blends.

26) The composition according to claim 6 wherein a TEM (transmission electron microscopy) shows visibly smaller polymer domains when compared to a non compatibilized blend control of the composition without the diphosphate

27) The composition of claim 6 wherein the resulting compatibilized blend has at least 10% greater flexural modulus when using ASTM D-790-00, compared to a non diphosphate treated control.

28) The composition according to claim 6 wherein the resulting compatibilizing blend has 10% greater flexural modulus when using a dynamic mechanical analyzer compared to a non diphosphate treated control.

29) The composition according to claim 6 wherein an SEM-EDX (scanning electron microscopy with X-ray element identification) of said composition shows a greater particle dispersion than a non diphosphate treated control.

30) The composition according to claims 6 wherein an X-ray diffraction pattern with the diphosphate treated clay composition shows greater uniform filler distribution throughout the thermoplastic polymer than does a non diphosphate treated control.

31) The composition according to claim 6 wherein diphosphate treated clay comprises 0.1%-50% by weight of the blend.

32) The composition according to claim 6 wherein the diphosphate treated clay is added into a melt phase of the thermoplastic polymer during processing.

33) The composition according to claim 6 wherein a solid filler is added to the thermoplastic after blending of the thermoplastic with the diphosphate and the clay.
